(19) United States
(12) Patent Application Publication
(10) Pub. No.: US 2025/0172581 A1
(43) Pub. Date: May 29, 2025

(54) METHOD FOR ASCERYAINING A ROTATIONAL SPEED AND/OR A MOVEMENT VARIABLE DERIVED FROM A ROTATIONAL SPEED, COMPUTER PROGRAM PRODUCT, COMPUTER DEVICE

(71) Applicant: Robert Bosch GmbH, Stuttgart (DE)

(72) Inventor: Jan Scheuing, Vellberg (DE)

(21) Appl. No.: 18/955,053

(22) Filed: Nov. 21, 2024

(30) Foreign Application Priority Data
Nov. 29, 2023 (DE) 10 2023 211 899.8

(51) Int. Cl. G01P 3/487; G01P 3/44

(52) U.S. Cl. CPC G01P 3/487; G01P 3/443

(57) ABSTRACT

A method for ascertaining a rotational speed and/or a movement variable derived from a rotational speed, in particular wheel circumferential speed, using a rotational speed sensor having a plurality of sensor elements and an incremental encoder wheel. Time intervals between temporally adjacent measurement events of the rotational speed sensor are ascertained, in particular continuously, wherein at least one estimated value for at least one duty cycle of a period including at least two of the measurement events, in particular a or a particular signal curve of the sensor elements, is ascertained depending on the ascertained time intervals. At least two of the time intervals are corrected depending on the estimated value, and the rotational speed and/or the movement variable are ascertained depending on the corrected time intervals.

### FIELD

The present invention relates to a method for ascertaining a rotational speed and/or a movement variable derived from a rotational speed, in particular a wheel circumferential speed, by means of a rotational speed sensor having a plurality of sensor elements and an incremental encoder wheel. Furthermore, the present invention relates to a computer program product which performs the above method if the computer program product is executed on a computer device. The present invention also relates to a computer device specifically configured to execute the computer program product or the aforementioned method.

### BACKGROUND INFORMATION

Methods of the aforementioned type are described in the related art. For example, such methods are used in the vehicle context. Many functions represented in an ABS/ESP control unit require a wheel circumferential speed (ω·r) of a wheel of a motor vehicle as an input variable. The wheel circumferential speed is typically ascertained by measuring the rotational speed using a rotational speed sensor. For example, Germany Patent Application No. DE 10 2015 213 572 A1 describes a method for operating such a rotational speed sensor with a signal encoder ring that has a plurality of magnetic elements uniformly distributed over its circumference with alternating magnetic orientation, and with a signal receiver that has a plurality of sensor elements for detecting the magnetic fields of the magnets, wherein information bits are generated depending on the magnetic field strengths detected by the sensor elements and are made available as a rotational speed information signal. For increasing a resolution of this rotational speed sensor, output signals from three sensor elements of the rotational speed sensor are in particular linked together.

### SUMMARY

In the method according to an example embodiment of the present invention, time intervals between temporally adjacent measurement events of the rotational speed sensor are ascertained, in particular continuously, at least one estimated value for at least one duty cycle of a period comprising at least two of the measurement events, in particular of a or a particular signal curve of the sensor elements, is ascertained depending on the ascertained time intervals, at least two of the time intervals are corrected depending on the estimated value, and the rotational speed and/or the movement variable are ascertained depending on the corrected time intervals. This advantageously improves the measurement accuracy of the rotational speed sensor, in particular, as mentioned above, in order to increase the accuracy when detecting a wheel circumferential speed of a wheel of a motor vehicle. The method can advantageously be used with the aforementioned rotational speed sensors based on the detection of magnetic field strengths, but is not limited thereto. Rather, it can be used with any type of rotational speed sensor with an incremental encoder. Preferably, a duty cycle is a value between 0 and 1 in relation to the length of the period and describes a relative temporal position of the measurement events or measurement pulses within the particular period. The present invention is based on the finding that the duty cycle as a relative position of the measurement events deviates from its ideal value in practice, in particular due to non-uniform scanning of the incremental encoder wheel, and that taking its actual value into account through the estimation according to the present invention improves measurement accuracy. Due to the correction, the corrected time intervals correspond to those of ideally uniform scanning of the incremental encoder wheel, in particular of a magnetic pole pair, so that systematic measurement errors, for example in the wheel circumferential speed signal derived therefrom, are minimized. In particular, the estimated value is ascertained continuously, after a specified number of measurement events in each case. In particular, the measurement events are generated depending on at least one signal curve of at least one of the sensor elements. In the specific example of a sinusoidal signal, with which zero crossings of the signal curve are detected as measurement events, the estimated value has a target value of ½, which is where the “average” zero crossing is in relation to a period of the sinusoidal signal. the position of which is thus described. Preferably, alternatively or additionally, reciprocals of the differences are corrected, and the rotational speed and/or the movement variable are ascertained depending on the corrected reciprocals. The reciprocal is in this case a frequency.

According to a preferred development of the present invention, it is provided that a specified signal value of a signal curve, in particular a zero crossing of a signal curve, is taken into account as a measurement event. By taking the signal value into account, the measurement event is characterized particularly advantageously in a simple manner. Preferably, at least one, in particular all, of the measurement events are generated when a specified signal value of the particular signal curve is reached, for example a zero-crossing event.

According to an example embodiment of the present invention, it is particularly preferably provided that a measurement event is ascertained depending on the signal curves of at least two of the sensor elements, in particular depending on a difference signal curve of at least two of the sensor elements. As a result, measurement events are particularly advantageously ascertained in a robust manner. For example, a zero crossing of the corresponding signal curve is taken into account as a measurement event.

According to a preferred development of the present invention, it is provided that at least one deviation value of the duty cycle from a specified ideal value and/or at least one reference value characterizing the duty cycle is ascertained depending on at least three consecutive time intervals, and that the estimated value is ascertained depending on the deviation value and/or reference value. By ascertaining and taking into account the deviation value and/or reference value in this way, a particularly advantageously simple ascertainment of the estimated value is ensured.

According to an example embodiment of the present invention, it is particularly preferably provided that the ascertained deviation value or reference value is filtered before the estimated value is ascertained, in particular by means of a discrete PT1 filter with a specified initialization value and a specified gain factor, wherein at least one difference between two deviation values or reference values assigned to consecutive time intervals is in particular ascertained for filtering. Such filtering of the deviation value or reference value has the advantage that the accuracy in ascertaining the estimated value is further improved.

According to a preferred development of the present invention, it is provided that at least one magnitude, in particular a plurality of magnitudes, of the difference between two estimated values, deviation values, and/or reference values assigned to consecutive time intervals is ascertained, that it is ascertained, depending on the magnitude or the plurality of magnitudes, whether consecutive estimated values converge, that the time intervals are only corrected if convergence has been recognized, and/or that a convergence rate is ascertained and the time intervals are corrected in a manner weighted with the convergence rate. By ascertaining and taking into account the convergence, it is advantageously ensured that the estimated values are ascertained in a robust manner. In the case of non-converging estimated values, the method is aborted in this respect in particular, or the time intervals are not corrected. Alternatively or additionally, a correction weighted with the convergence rate is in particular carried out.

According to an example embodiment of the present invention, it is particularly preferably provided that, for recognizing a convergence, the magnitude, the plurality of magnitudes, and/or an average value of the plurality of magnitudes is compared to a specified first threshold value, that convergence is recognized if the threshold value is undershot, in particular by a specified number of magnitudes or average values, and/or that a recognized convergence is discarded if a second specified threshold value, which is higher than the first threshold value, is at least reached, in particular exceeded, by at least one of the magnitudes and/or average values, and/or a third specified threshold value is at least reached, in particular exceeded, by at least one of the time intervals. This has the advantage that actual convergences are correctly recognized.

According to a preferred development of the present invention, it is provided that at least two signal curves are generated, in particular from sensor signals, calculated together in different ways, of at least two sensor elements of the rotational speed sensor in each case, that consecutive measurement events are each assigned to different signal curves, and that in each case estimated values for one duty cycle are ascertained for each of the signal curves. This advantageously ensures that a reliable distinction is made between the signal curves and that only estimated values that can be assigned to the particular signal curve are ascertained.

According to an example embodiment of the present invention, it is particularly preferably provided that at least one estimated value is ascertained for at least one relative offset of two consecutive measurement events assigned to different signal curves, and that the time intervals are corrected depending on the estimated value. Taking into account the offset estimated value has the advantage that the accuracy in the correction of the time intervals is further improved. In this respect, the offset estimated value is ascertained in addition to the duty-cycle estimated value and taken into account in the correction.

According to a preferred development of the present invention, it is provided that a convergence rate and/or a deviation value of the particular duty cycle from a specified ideal value for the estimated values is ascertained in each case, and that a duty cycle is in each case assigned to one of the at least two different signal curves, depending on the ascertained convergence rates and/or deviation values. This advantageously ensures that the corresponding estimated values and thus the underlying measurement events are correctly classified, i.e., assigned to the correct signal curve.

It is particularly preferably provided that the duty cycle assigned to the estimated values with the higher convergence rate and/or the smaller deviation value is assigned to a first signal curve, and in each case the other duty cycle is assigned to a second signal curve, in particular by swapping the estimated values. This ensures a particularly simple classification of the estimated values and the underlying measurement events.

According to a preferred development of the present invention, it is provided that measurement events assigned to one of the signal curves are discarded if a fourth specified threshold value is undershot by at least one of the time intervals. This advantageously ensures that a computational effort of the method is reduced starting from a certain threshold value, for example by ignoring corresponding measurement events starting from a certain vehicle speed, and that the required measurement accuracy is ensured at the same time.

According to an example embodiment of the present invention, it is particularly preferably provided that the incremental encoder wheel is designed to be magnetic and that at least three sensor elements, in particular Hall sensors or magnetoresistive sensors, are arranged equidistantly in a row, wherein a difference between sensor signals of two, in particular of the two outer, sensor elements is generated as a first signal curve, and a difference between one of the sensor signals of one, in particular the middle, sensor element and an average value of sensor signals of two other, in particular the two outer, sensor elements is generated as a second signal curve. This has the advantage that the accuracy in ascertaining the movement variable is further improved. In this respect, virtual additional signals are generated between two measurement events. In particular, a zero-crossing event of a periodic signal curve, in particular of a magnetic flux density, in particular corresponding to an arc length of a magnetic pole pair, is in each case specified as the corresponding signal value. For example, Hall sensor elements are used, wherein zero crossings of the curves of the magnetic flux density of the sensor elements are output as measurement events, i.e., two per magnetic pole pair. For increasing the accuracy, the mentioned quasi-virtual additional measurement events are then generated, which are based on difference signals of the Hall sensor elements.

A computer program product according to the present invention for execution on a computer device is characterized in that it performs the method according to the present invention when used as intended. This results in the advantages already mentioned. Preferably, a data carrier with the computer program product according to the present invention stored thereon is provided.

A computer device with features of the present invention is characterized in that the computer device is specifically configured to perform the method according to the present invention or to execute the computer program product according to the present invention. This also results in the advantages already mentioned above. Preferably, the computer device is a control device assigned to a motor vehicle, in particular arranged in the motor vehicle.

Further preferred features and combinations of features result from what was described above and from the rest of the disclosure herein. The present invention is explained in more detail below with reference to the figures.

### BRIEF DESCRIPTION OF THE DRAWINGS

FIG. 1 shows a rotational speed sensor.

FIG. 2 shows first signal curve diagrams.

FIG. 3 shows a method for ascertaining a rotational speed and/or a movement variable derived from a rotational speed, according to an example embodiment of the present invention.

FIG. 4 shows a second signal curve diagram.

### DETAILED DESCRIPTION EXAMPLE EMBODIMENTS

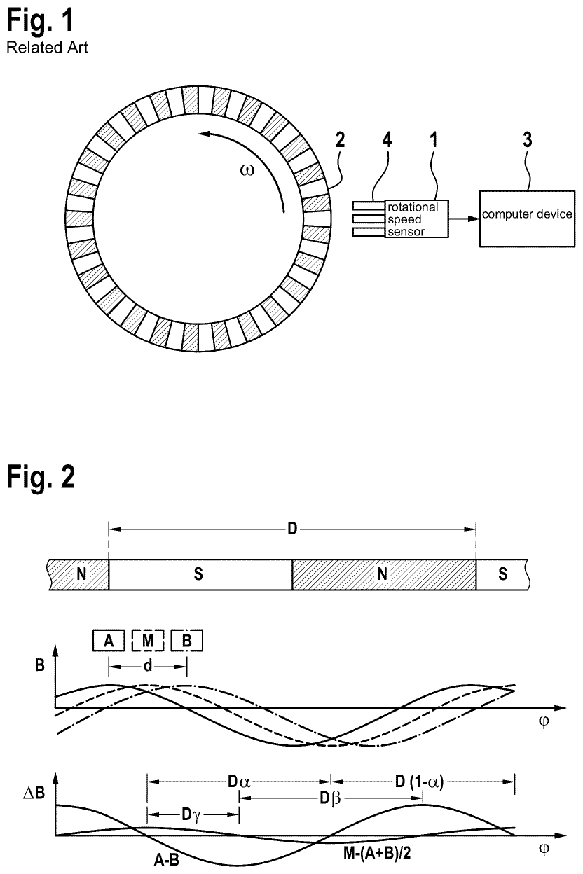

FIG. 1 shows a conventional rotational speed sensor 1, such as is used for ascertaining a wheel circumferential speed ω·r, which can then serve as an input variable for ABS/ESP control, as mentioned above. The rotational speed sensor 1 is designed to detect (measurement) events, for example magnetic flux changes, of an encoder, rotating with a wheel, or incremental encoder wheel 2 and to transmit them to a computer device 3, here a control unit. The computer device 3 is in turn designed to ascertain a time interval Δt(i) between the i-th event and the preceding, i−1-th event, in particular by means of a high-frequency counter (typically 10 MHZ), and to estimate, depending thereon, an instantaneous wheel rotational speed and, derived therefrom, the wheel circumferential speed.

Usually, magnetic multipole wheels are used as the encoders or incremental encoder wheels 2. The incremental encoder uses a plurality of sensor elements 4, here three, arranged equidistantly in a row (shown one above the other in FIG. 1). The sensor elements 4 are in particular designed as Hall encoders, AMR sensors, GMR sensors, and/or TMR sensors and are designed to detect the magnetic field emanating from the incremental encoder wheel 2, for example in a tangential direction, and in each case to output a measured variable dependent thereon, for example a Hall voltage.

The measurement events transmitted to the computer device 3 are correspondingly derived from the measured variables of the sensor elements 4. For example, a signal zero crossing of the magnetic flux density is used as a measurement event. When the wheel moves, exactly two events thus take place for each magnetic pole pair of the incremental encoder wheel 2 on the arc length D. For reducing offset errors of the zero position, for example due to temperature effects, the difference signal of the signals of the two outer sensor elements 4, here referred to as A and B (corresponding to the lower and the upper sensor element 4 in FIG. 1), is usually considered as a first signal curve. The signal of the middle sensor element 4, here referred to as M (corresponding to the middle sensor element 4 in FIG. 1), is used, for example, for determining the direction of rotation.

Ideally, the magnetic poles within the pole pair have the same length and the zero position of the difference signal does not have any offset error; in this case, the events take place at a spatial distance D/2. In practice, the relative position, known as duty cycle α, of the events deviates from the ideal value ½, typically by ±5% (the duty cycle is thus a value between 0 and 1).

In an ideal incremental encoder wheel 2, each pole pair has the same arc length D, i.e., all pole pairs are uniformly distributed over the encoder circumference. For manufacturing-related reasons, pitch errors occur in practice, typically up to ±5%. The resulting patterns, which recur periodically with the wheel, are in particular learned and compensated by evaluating the sequence of events in the computer device 3; a corresponding method is described, for example, in “Increasing signal accuracy of automotive wheel-speed sensors by on-line learning,” R. Schwarz, O. Nelles, P. Scheerer, and R. Isermann in American Control Conference, Albuquerque, New Mexico, 1997. Any such irregularities between the pole pairs of an encoder wheel (pitch errors) are preferably considered non-existent or sufficiently compensated in the method to be described below.

Newer developments, especially in the context of automated parking, require a higher distance resolution in the sense of a higher number of events per wheel revolution. In this case, encoder wheels with a significantly larger number of pole pairs are not effective for technical and economic reasons. However, it is possible to increase the number of measurement events per pole pair, for example by taking into account additional signal curves of individual signals calculated together. In particular, an additional, second signal curve is derived from the zero crossing of the difference signal of the middle sensor element M and a signal average value of the two outer sensor elements A and B.

The relative position of the now four events per pole pair can be described using three independent variables. The existing duty cycle α of the measurement events of the first signal curve (ideal value ½), the duty cycle β of the measurement events of the second signal curve (ideal value ½), and the relative shift γ of the measurement events as the offset of the signal curves to one another (ideal value ¼) are used below for describing the relative position. This does not represent a limitation of the present invention; differently chosen independent variables can always be transformed into the chosen three.

In general, the statistical properties of the measurement events of the second signal curve as intermediate events differ from those of the measurement events of the first signal curve as standard events. For example, the different linking of the measured variables ensures a typically smaller amplitude of the difference signal M−(A+B)/2, which amplitude depends on the ratio of a sensor element distance d (indicated in FIG. 2) to the arc length D, and thus a higher sensitivity in the temporal position determination of the corresponding measurement events, for example in comparison to offset errors of the zero position and/or a tilting of the incremental encoder with the sensor elements 4 in the magnetic field of the incremental encoder wheel 2 as the encoder.

This is reflected in the measurement in the form of an increased spread of β in comparison to α. Due to the spatial and temporal scanning of the magnetic field, wherein the spatial component now becomes relevant, the accuracy of the geometric center position of the sensor element M also affects the duty cycle value β of the intermediate events.

These fundamental relationships are shown in FIG. 2. FIG. 2 shows a detail of the incremental encoder wheel 2 as an encoder with alternating magnetic north pole N and magnetic south pole S. One of these pole pairs has the arc length D in each case. Below, in a corresponding diagram, exemplary, correspondingly sinusoidal, curves of the magnetic flux density B in the far field of the encoder at the three sensor elements A, M, and B, when the encoder moves to the right, are plotted over the encoder rotation angle φ. In another corresponding diagram, the described used difference signals A−B and M−(A+B)/2 are plotted over the rotation angle φ. Each arc length D correspondingly comprises one period of the corresponding signal, and thus two zero-crossing events for each of the signal curves.

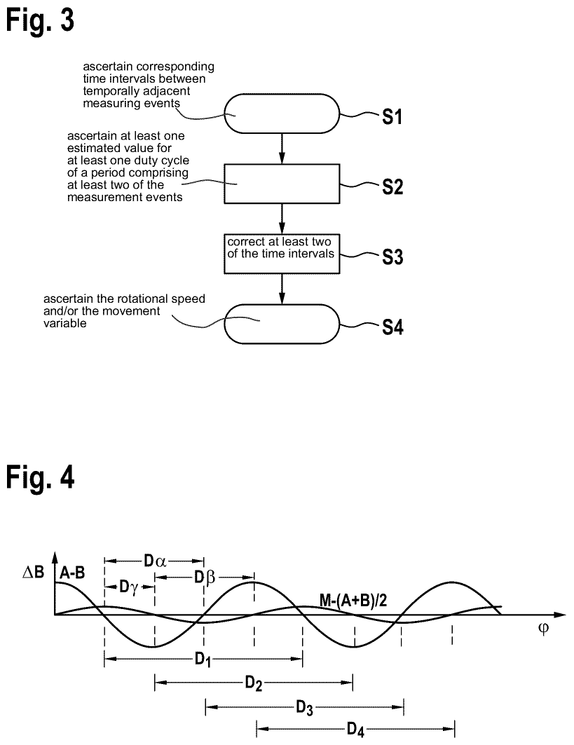

In the following, an advantageous method for ascertaining a rotational speed and/or a movement variable, derived from a rotational speed, by means of a rotational speed sensor, in particular by means of the rotational speed sensor 1 described above, is described with reference to FIG. 3. For this purpose, FIG. 3 shows the method using a flow chart. In particular, the method ensures that the accuracy in ascertaining the corresponding variables is improved by taking into account the above-described deviation of the duty cycles from their corresponding ideal values. The method is performed in particular by means of the computer device 3.

In a step S1, the method begins by ascertaining, in particular continuously, corresponding time intervals between temporally adjacent measurement events of the rotational speed sensor. A specified signal value of a signal curve, in particular a zero crossing of a signal curve, is preferably taken into account as a measurement event. Particularly preferably, a measurement event is ascertained depending on the signal curves of at least two of the sensor elements, in particular depending on a difference signal curve of at least two of the sensor elements. Taken into account, for example, are zero crossings of the two signal curves (described with reference to FIGS. 1 and 2), which result from correspondingly linked difference signals of the sensor elements 4. However, for the method according to the present invention, it is generally sufficient if only one signal curve, for example the first signal curve as the difference signal of the sensor elements A and B, is correspondingly taken into account.

For example, at least three sensor elements, in particular Hall sensors or magnetoresistive sensors, are arranged equidistantly in a row, as described in FIGS. 1 and 2, wherein a difference between sensor signals of two, in particular of the two outer, sensor elements is generated as a first signal curve, and a difference between one of the sensor signals of one, in particular the middle, sensor element and an average value of sensor signals of two other, in particular the two outer, sensor elements is generated as a second signal curve. In particular, but not necessarily, the incremental encoder wheel is designed to be magnetic in this case. The method can thus be used just as advantageously for optical sensing or another type of event transmission or measurement.

In a subsequent step S2, at least one estimated value for at least one duty cycle of a period comprising at least two of the measurement events, in particular a or a particular signal curve of the sensor elements, is ascertained depending on the ascertained time intervals.

With reference to FIGS. 1 and 2, the measured time intervals of all measurement events recognized by the rotational speed sensor are then, for example, used to estimate their relative position within the magnetic pole pair in the form of the duty cycles α and β as well as the relative shift γ and, based thereon, to classify the corresponding measurement events on the basis of the duty-cycle estimated values and their convergence speed, i.e., to assign them to their particular signal curve, as described in detail below.

FIG. 4 shows a corresponding example of the above-described rotational speed sensor 1 with the three sensor elements 4. FIG. 4 shows the first and second signal curves plotted over a larger range of the rotation angle φ, so that of the four different events per arc length D, two similar measurement events (of two consecutive arc lengths D or periods), which in this respect each have a distance D1, D2, D3, D4 from one another, are shown in each case. Also shown in each case are the duty cycle α of the measurement events of the first signal curve, the duty cycle β of the measurement events of the second signal curve, and the relative offset γ, as described above.

In the specific exemplary embodiment described with reference to FIGS. 1, 2, and 4, the relative position of the events within the arc length D of a magnetic pole pair is estimated from the continuous sequence of measured time intervals between measurement events Δt(i). In the case of doubled resolution, i.e., when taking into account the second signal curve, it is assumed that each pole pair is always characterized by four adjacent time intervals, i.e., no measurement event is in particular detected too much or too little.

Preferably, for this purpose, at least one deviation value of the duty cycle from a specified ideal value and/or at least one reference value characterizing the duty cycle is ascertained depending on at least three consecutive time intervals, and the estimated value is ascertained depending on the deviation value and/or reference value.

In the simplest case, only one signal curve is considered, for example the first signal curve (A−B) of FIG. 2. The, in this case one, duty cycle value \hat{α} is in particular (first form) estimated after every second event (i=2n with n∈ [symbol] ):

$$\hat{α} ( n ) = \frac{Δ t ( 2 n - 1 )}{Δ t ( 2 n - 1 ) + Δ t ( 2 n )}$$

Alternatively, the deviations \tilde{α} from the ideal value are estimated first:

$$\tilde{α} ( n ) = \frac{Δ t ( 2 n - 1 )}{Δ t ( 2 n - 1 ) + Δ t ( 2 n )} - \frac{1}{2}$$

Depending thereon, the estimated values \hat{α} are subsequently ascertained:

$$\hat{α} ( n ) = \frac{1}{2} + \tilde{α} ( n )$$

Preferably, at least two signal curves, in particular from sensor signals, calculated together in different ways, of at least two sensor elements of the rotational speed sensor in each case are generated as described above, consecutive measurement events are in each case assigned to different signal curves, and in each case estimated values for one duty cycle are ascertained for each of the signal curves. In this case, at least one estimated value for at least one relative offset of two consecutive measurement events assigned to different signal curves is preferably additionally ascertained.

In the specific exemplary embodiment, the duty cycles \hat{α} and \hat{β} and the relative offset \hat{γ} are in particular (first form) estimated after every fourth event (i=4n with n∈ [symbol] ):

$$\hat{α} ( n ) = \frac{Δ t ( 4 n - 3 ) + Δ t ( 4 n - 2 )}{{\sum }_{k = 0}^{3} Δ t ( 4 n - k )}$$

$$\hat{β} ( n ) = \frac{Δ t ( 4 n - 2 ) + Δ t ( 4 n - 1 )}{{\sum }_{k = 0}^{3} Δ t ( 4 n - k )}$$

$$\hat{γ} ( n ) = \frac{Δ t ( 4 n - 3 )}{{\sum }_{k = 0}^{3} Δ t ( 4 n - k )}$$

The corresponding procedure can be generalized correspondingly for further increases in resolution. For example, if 8 events per arc length, in particular of a magnetic pole pair, are planned, the four duty cycle values \hat{α}, [symbol] , [symbol] , and [symbol] and the relative offset values [symbol] , [symbol] , and [symbol] are estimated after every eighth event (i=8n with n∈ [symbol] ):

$$\hat{α} ( n ) = \frac{{\sum }_{k = 4}^{7} Δ t ( 8 n - k )}{{\sum }_{k = 0}^{7} Δ t ( 8 n - k )}$$

$$( n ) = \frac{{\sum }_{k = 3}^{6} Δ t ( 8 n - k )}{{\sum }_{k = 0}^{7} Δ t ( 8 n - k )}$$

$$( n ) = \frac{{\sum }_{k = 2}^{5} Δ t ( 8 n - k )}{{\sum }_{k = 0}^{7} Δ t ( 8 n - k )}$$

$$( n ) = \frac{{\sum }_{k = 1}^{4} Δ t ( 8 n - k )}{{\sum }_{k = 0}^{7} Δ t ( 8 n - k )}$$

$$( n ) = \frac{Δ t ( 8 n - 7 )}{{\sum }_{k = 0}^{7} Δ t ( 8 n - k )}$$

$$( n ) = \frac{Δ t ( 8 n - 6 )}{{\sum }_{k = 0}^{7} Δ t ( 8 n - k )}$$

$$( n ) = \frac{Δ t ( 8 n - 5 )}{{\sum }_{k = 0}^{7} Δ t ( 8 n - k )}$$

Coming back to the specific exemplary embodiment, an alternative representation first estimates the deviations \tilde{α}, \tilde{β}, \tilde{γ} from the particular ideal values (analogously, a generalization is possible, for example to the aforementioned 8 events):

$$\tilde{α} ( n ) = \frac{Δ t ( 4 n - 3 ) + Δ t ( 4 n - 2 )}{{\sum }_{k = 0}^{3} Δ t ( 4 n - k )} - \frac{1}{2}$$

$$\tilde{β} ( n ) = \frac{Δ t ( 4 n - 2 ) + Δ t ( 4 n - 1 )}{{\sum }_{k = 0}^{3} Δ t ( 4 n - k )} - \frac{1}{2}$$

$$\tilde{γ} ( n ) = \frac{Δ t ( 4 n - 3 )}{{\sum }_{k = 0}^{3} Δ t ( 4 n - k )} - \frac{1}{4}$$

Depending thereon, the estimated values \tilde{α}, \tilde{β}, \tilde{γ} are subsequently ascertained:

$$\hat{α} ( n ) = \frac{1}{2} + \tilde{α} ( n )$$

$$\hat{β} ( n ) = \frac{1}{2} + \tilde{β} ( n )$$

$$\hat{γ} ( n ) = \frac{1}{4} + \tilde{γ} ( n )$$

In particular, the ascertained deviation value or reference value is filtered before the estimated value is ascertained, in particular by means of a discrete PT1 filter with a specified initialization value and a specified gain factor, wherein at least one difference between two deviation values or reference values assigned to consecutive time intervals is in particular ascertained for filtering.

In the simplest case, only one signal curve is also considered here, for example the first signal curve (A−B) of FIG. 2. The deviations from the ideal values are then preferably (second form) filtered, in particular in the form of a discrete PT1 filter with the initialization value \tilde{α} (0)=0 and the gain factor k (for example k=3%):

$$( n ) = \frac{Δ t ( 2 n - 1 )}{Δ t ( 2 n - 1 ) + Δ t ( 2 n )} - \frac{1}{2} - \tilde{α} ( n - 1 )$$

$$\tilde{α} ( n ) = \tilde{α} ( n - 1 ) + k \cdot ( n )$$

In the specific exemplary embodiment, the deviations from the ideal values are in particular (second form) filtered for both signal curves (analogously, a generalization is possible, for example to the aforementioned 8 events), in particular in the form of a discrete PT1 filter with the initialization values \tilde{α} (0)=\tilde{β}(0)=\tilde{γ} (0)=0 and the gain factor k (for example k=3%):

$$( n ) = \frac{Δ t ( 4 n - 3 ) + Δ t ( 4 n - 2 )}{{\sum }_{k = 0}^{3} Δ t ( 4 n - k )} - \frac{1}{2} - \tilde{α} ( n - 1 )$$

$$\tilde{α} ( n ) = \tilde{α} ( n - 1 ) + k \cdot ( n )$$

$$( n ) = \frac{Δ t ( 4 n - 2 ) + Δ t ( 4 n - 1 )}{{\sum }_{k = 0}^{3} Δ t ( 4 n - k )} - \frac{1}{2} - \tilde{β} ( n - 1 )$$

$$\tilde{β} ( n ) = \tilde{β} ( n - 1 ) + k \cdot ( n )$$

$$( n ) = \frac{Δ t ( 4 n - 3 )}{{\sum }_{k = 0}^{3} Δ t ( 4 n - k )} - \frac{1}{4} - \tilde{γ} ( n - 1 )$$

$$\tilde{γ} ( n ) = \tilde{γ} ( n - 1 ) + k \cdot ( n )$$

An advantageously increased estimation quality, in particular when the measured time intervals change due to speed changes, is provided by a further preferred calculation rule (third form), with which a reference value in the denominator is divided in half between the two pole pairs that result from the duration of the measured pole and its predecessor or successor, and a corresponding filtering is carried out based thereon.

In the simplest case, only one signal curve is also considered here, for example the first signal curve (A−B) of FIG. 2. The result is:

$$( n ) = \frac{Δ t ( 2 n - 1 )}{2 \cdot ( Δ t ( 2 n - 2 ) + Δ t ( 2 n - 1 ) )} - \frac{Δ t ( 2 n )}{2 \cdot ( Δ t ( 2 n - 1 ) + Δ t ( 2 n ) )} - \tilde{α} ( n - 1 )$$

For the specific exemplary embodiment, taking into account two signal curves, the result is (analogously, a generalization is possible, for example to the aforementioned 8 events):

$$( n ) = \frac{Δ t ( 4 n - 3 ) + Δ t ( 4 n - 2 )}{2 \cdot {\sum }_{k = 2}^{5} Δ t ( 4 n - k )} - \frac{Δ t ( 4 n - 1 ) + Δ t ( 4 n )}{2 \cdot {\sum }_{k = 0}^{3} Δ t ( 4 n - k )} - \tilde{α} ( n - 1 )$$

$$( n ) = \frac{Δ t ( 4 n - 2 ) + Δ t ( 4 n - 1 )}{2 \cdot {\sum }_{k = 1}^{4} Δ t ( 4 n - k )} - \frac{Δ t ( 4 n - 4 ) + Δ t ( 4 n - 3 )}{2 \cdot {\sum }_{k = 3}^{6} Δ t ( 4 n - k )} - \tilde{β} ( n - 1 )$$

$$( n ) = \frac{Δ t ( 4 n - 3 )}{2 \cdot {\sum }_{k = 3}^{6} Δ t ( 4 n - k )} - \frac{Δ t ( 4 n - 3 )}{2 \cdot {\sum }_{k = 0}^{3} Δ t ( 4 n - k )} - \tilde{γ} ( n - 1 )$$

Particularly preferably, a convergence rate and/or a deviation value of the particular duty cycle from a specified ideal value for the estimated values is ascertained in each case, and a duty cycle is in each case assigned to one of the at least two different signal curves, depending on the ascertained convergence rates and/or deviation values. In particular, the duty cycle assigned to the estimated values with the higher convergence rate and/or the smaller deviation value is assigned to a first signal curve, and in each case the other duty cycle is assigned to a second signal curve, in particular by swapping the estimated values.

For example, if the type of event is not known in the specific exemplary embodiment, the assignment of the estimated duty cycle to the curves is initially arbitrary. If one of the two duty-cycle estimated values \hat{α}(n) or \hat{β}(n) converges significantly faster than the other, for example in that the number of times the threshold value is undershot when recognizing convergence is more than twice as high, it is classified as the duty cycle of the first signal curve, the other as that of the second signal curve. This is based on the assumption of a higher spread in the temporal position determination of the measurement events of the second signal curve.

Alternatively or additionally, the duty-cycle estimated value \hat{α}(n) or \hat{β}(n) that is closer to the ideal value of ½ is classified as the duty cycle of the first signal curve, the other as that of the second signal curve. This is based on the assumption of a worse offset adjustment of the measurement events of the second signal curve. The two criteria can be linked in different ways, preferably classification takes place first on the basis of the convergence speed and secondarily, in case of ambiguity, on the basis of the convergence value.

If the initial, arbitrary assignment of the estimated duty cycles to the event types turns out to be incorrect during the classification (\hat{β}(n) is classified as the duty cycle of the first signal curve), the estimated values are preferably swapped:

$${\hat{α}}_{new} ( n ) = 1 - \hat{β} ( n )$$

$${\hat{β}}_{new} ( n ) = \hat{α} ( n )$$

$${\hat{γ}}_{new} ( n ) = \hat{α} ( n ) - \hat{γ} ( n )$$

Even if the type of events is known, the corresponding classification on the basis of the statistical signal properties is still advantageous for a plausibility check and/or monitoring. The classification can, for example, be applied analogously to the aforementioned 8 events and generalized.

In particular, measurement events assigned to one of the signal curves are discarded if a fourth specified threshold value is undershot by at least one of the time intervals. In particular, the calculation of the movement variable can thus only be carried out on the basis of the measurement events of the first signal curve that are classified as such, and explicitly without using the measurement events of the second signal curve. This advantageously reduces computational effort and/or signal noise in the calculated output signal.

Preferably, the estimation is aborted in the case of very large time intervals, which, for example, come close to a wheel standstill when the rotational speed sensor is used on a wheel of a motor vehicle, in order to avoid the special case of a reversal of the direction of rotation, in the case of which the assumption of four measurement events per pole pair may not apply. In particular, the estimation is temporarily paused, for example for temporarily reducing the computational load or in the case of expected poor convergence conditions, for example a sharp change in speed or driving on unpaved roads when used in a motor vehicle.

After an interruption of the estimation, as described above, in particular close to a wheel standstill, a new initialization is preferably carried out in order to achieve faster convergence of the estimated values in the case of a reversal of the direction of rotation.

In a step S3, at least two of the time intervals are now corrected depending on the estimated value(s), so that the corrected time intervals correspond to those of an ideally uniform scanning of the incremental encoder wheel, in particular of a magnetic pole pair with reference to FIGS. 1 and 2, and systematic measurement errors in the wheel circumferential speed signal derived therefrom are minimized.

In the simplest case, only one signal curve is again considered, for example the first signal curve (A−B) of FIG. 2. Then, the estimated value \hat{α} is in particular used continuously for correcting the measured time differences Δt(i), so that the corrected time differences [symbol] (i) correspond to those of an ideally uniform scanning of the magnetic pole pair:

$$( i ) = Δ t ( i ) \cdot \{ \begin{matrix}\frac{1}{2 \cdot ( 1 - \hat{α} )} , i = 2 n \\ \frac{1}{2 \cdot \hat{α}} , i = 2 n - 1\end{matrix}$$

In the specific exemplary embodiment, the estimated values \hat{α}, \hat{β}, and \hat{γ} are analogously used, preferably continuously, for correcting the measured time differences Δt(i) (the following considerations can, for example, be applied analogously to the aforementioned 8 events and generalized):

$$( i ) = Δ t ( i ) \cdot \{ \begin{matrix}\frac{1}{4 \cdot ( 1 - \hat{β} - \hat{γ} )} , i = 4 n \\ \frac{1}{4 \cdot ( \hat{β} - \hat{α} + \hat{γ} )} , i = 4 n - 1 \\ \frac{1}{4 \cdot ( \hat{α} - \hat{γ} )} , i = 4 n - 2 \\ \frac{1}{4 \cdot \hat{γ}} , i = 4 n - 3\end{matrix}$$

In an alternative approximation for sufficiently small deviations from the ideal values, the correction can also be applied only after the time difference reciprocals have been formed, so that the following corrected pulse frequency sequence is used for the subsequent speed estimation when only one signal curve is considered:

$$\tilde{f} ( i ) = \frac{2}{Δ t ( i )} \cdot \{ \begin{matrix}\hat{α} , i = 2 n \\ 1 - \hat{α} , i = 2 n - 1\end{matrix}$$

Analogously, in the specific exemplary embodiment, the following corrected pulse frequency sequence is used when considering both signal curves:

$$\tilde{f} ( i ) = \frac{4}{Δ t ( i )} \cdot \{ \begin{matrix}1 - \hat{β} - \hat{γ} , i = 4 n \\ \hat{β} - \hat{α} + \hat{γ} , i = 4 n - 1 \\ \hat{α} - \hat{γ} , i = 4 n - 2 \\ \hat{γ} , i = 4 n - 3\end{matrix}$$

In relation to the determination of the movement variable, in particular wheel rotational speed or wheel circumferential speed, the advantages of higher-resolution incremental encoders are substantially limited to low rotational speeds. Due to the incremental encoder principle, the information age of the rotational speed signal, i.e., the time interval between the validity time between two events and the availability time after the second event, increases reciprocally with decreasing speed.

The provided doubling of the resolution in the specific exemplary embodiment halves the information age of the rotational speed signal. This is relevant in the rotational speed range of, for example, less than one event per 5 ms. A relative error, such as a not yet converged and therefore uncorrected duty cycle of the second signal curve, has only a small effect (at low rotational speeds) on the absolute accuracy of a rotational speed estimation.

At rotational speeds above this range, the halving of the information age is negligible; here, a possible disadvantage in terms of accuracy of the intermediate pulses as measurement events of the second signal curve and the disadvantage of a computational effort that increases linearly with the number of events outweigh the advantages.

Preferably, the movement variable is therefore estimated for higher rotational speeds as described above, explicitly without using the intermediate pulses classified as such, i.e., only at every second event and by accumulating the measured time differences over the intermediate pulse with the following alternative pulse frequency sequence:

$${\tilde{f}}_{fast} ( i ) = \frac{4}{Δ t ( i ) + Δ t ( i - 1 )} \cdot \{ \begin{matrix}1 - \hat{α} , i = 4 n \\ \hat{α} , i = 4 n - 2\end{matrix}$$

Particularly preferably, at least one magnitude, in particular a plurality of magnitudes, of the difference between two estimated values, deviation values, and/or reference values assigned to consecutive time intervals is ascertained beforehand. In particular, it is then ascertained, depending on the magnitude or the plurality of magnitudes, whether consecutive estimated values converge, and the time intervals are only corrected if convergence has been recognized. Alternatively or additionally, a convergence rate is ascertained and the time intervals are corrected in a manner weighted with the convergence rate.

In this case, for recognizing a convergence, the magnitude, the plurality of magnitudes, and/or an average value of the plurality of magnitudes are preferably compared to a specified first threshold value, and convergence is recognized if the threshold value is undershot, in particular by a specified number of magnitudes or average values.

Alternatively or additionally, a recognized convergence is discarded if a second specified threshold value, which is higher than the first threshold value, is at least reached, in particular exceeded, by at least one of the magnitudes and/or average values, and/or a third specified threshold value is at least reached, in particular exceeded, by at least one of the time intervals.

In the simplest case, only one signal curve is again considered, for example the first signal curve (A−B) of FIG. 2. Then, the convergence of the estimation is in particular concluded from the magnitude of the estimated value change |\hat{α}(n)−\hat{α}(n−1)| or, in the second and third forms, alternatively, from the change difference magnitude change | [symbol] (n)|.

In the specific exemplary embodiment, when taking into account both signal curves, the convergence of the particular estimation is in particular concluded from the magnitude of the estimated value change |\hat{α}(n)−\hat{α}(n−1)|, |\hat{β}(n)−\hat{β}(n−1)|, or |\hat{γ}(n)−\hat{γ}(n−1)| or, in the second and third forms, alternatively, from the change difference magnitude | [symbol] (n)|, | [symbol] (n)|, or | [symbol] (n)|.

As an implementation with a particularly low computational effort, each magnitude is preferably compared to a threshold value of, for example, 0.1% in each case and, if the threshold value is continuously undershot over, for example, 100 multipoles n, convergence is recognized. Alternatively, for example, averaging/filtering of the magnitude values and corresponding threshold value comparisons of the average value are provided.

Preferably, as described, the correction of the measured time intervals takes place only with converged estimated values. Alternatively, a correction weighted with the convergence rate is provided. A recognized convergence is in particular discarded if, for example, there are large time differences (close to standstill) or if the magnitude exceeds a second, higher threshold value of, for example, 0.5%, for example due to increased signal noise when driving on unpaved roads.

Finally, in a step S4, the rotational speed and/or the movement variable, for example, as described above, the wheel circumferential speed, are ascertained depending on the corrected time intervals. Preferably, the method is performed continuously.

In particular, for the ascertainment, further signal processing steps, such as reciprocal value formation, pitch error correction, anti-aliasing filtering, scanning rate conversion, consideration of the number of multipoles per encoder and the wheel circumference are carried out in addition to the correction of the duty cycle. Preferably, the duty cycle correction according to the present invention is first carried out in combination with the reciprocal value formation, and one of the pulse frequency sequences described is preferably used for all subsequent steps.

1-15. (canceled)

16. A method for ascertaining a rotational speed and/or a movement variable derived from a rotational speed, including a wheel circumferential speed, using a rotational speed sensor having a plurality of sensor elements and an incremental encoder wheel, the method comprising the following steps:
ascertaining time intervals between temporally adjacent measurement events of the rotational speed sensor, continuously;
ascertaining at least one estimated value for at least one duty cycle of a period including at least two of the measurement events, depending on the ascertained time intervals;
correcting at least two of the time intervals depending on the estimated value; and
ascertaining the rotational speed and/or the movement variable depending on the corrected time intervals.

17. The method according to claim 16, wherein a specified signal value of a signal curve of the sensor elements, including a zero crossing of a signal curve, is taken into account as a measurement event.

18. The method according to claim 16, wherein a measurement event is ascertained depending on signal curves of at least two of the sensor elements, and depending on a difference signal curve of at least two of the sensor elements.

19. The method according to claim 16, wherein at least one deviation value of the duty cycle from a specified ideal value and/or at least one reference value characterizing the duty cycle, is ascertained depending on at least three consecutive time intervals, and the estimated value is ascertained depending on the deviation value and/or the reference value.

20. The method according to claim 19, wherein the ascertained deviation value or the ascertained reference value is filtered before the estimated value is ascertained, using a discrete PT1 filter with a specified initialization value and a specified gain factor, wherein at least one difference between two deviation values or reference values assigned to consecutive time intervals is ascertained for filtering.

21. The method according to claim 16, wherein at least one magnitude or a plurality of magnitudes, of the difference between two estimated values, and/or deviation values, and/or reference values assigned to consecutive time intervals is ascertained, wherein it is ascertained, depending on the magnitude or the plurality of magnitudes, whether consecutive estimated values converge, and wherein: (i) the time intervals are corrected only when convergence has been recognized, and/or (ii) a convergence rate is ascertained and the time intervals are corrected in a manner weighted with the convergence rate.

22. The method according to claim 21, wherein, for recognizing a convergence, the magnitude, and/or the plurality of magnitudes, and/or an average value of the plurality of magnitudes is compared to a specified first threshold value, wherein convergence is recognized when the first threshold value is undershot by a specified number of magnitudes or average values, and/or wherein a recognized convergence is discarded when: (i) a second specified threshold value, which is higher than the first threshold value, is at least reached or exceeded, by at least one of the magnitudes and/or average values, and/or (ii) a third specified threshold value is at least reached or exceeded, by at least one of the time intervals.

23. The method according to claim 16, wherein at least two signal curves are generated from sensor signals, calculated together in different ways, of at least two sensor elements of the rotational speed sensor in each case, wherein consecutive measurement events are in each case assigned to different signal curves, and wherein, in each case, estimated values for one duty cycle are ascertained for each of the signal curves.

24. The method according to claim 16, wherein at least one estimated value is ascertained for at least one relative offset of two consecutive measurement events assigned to different signal curves, and wherein the time intervals are corrected depending on the estimated value.

25. The method according to claim 16 wherein a convergence rate and/or a deviation value of a respective duty cycle from a specified ideal value for the estimated values is ascertained in each case, and wherein each respective duty cycle is in each case assigned to one of the at least two different signal curves, depending on the ascertained convergence rates and/or deviation values.

26. The method according to claim 25, wherein the duty cycle assigned to the estimated values with a higher convergence rate and/or a smaller deviation value is assigned to a first signal curve, and in each case the other duty cycle is assigned to a second signal curve, by swapping the estimated values.

27. The method according to claim 18, wherein measurement events assigned to one of the signal curves are discarded when a fourth specified threshold value is undershot by at least one of the time intervals.

28. The method according to claim 16, wherein the incremental encoder wheel is magnetic and at least three sensor elements including Hall sensors or magnetoresistive sensors, are arranged equidistantly in a row, wherein a difference between sensor signals of two outer ones of the sensor elements is generated as a first signal curve, and a difference between one sensor signal of a middle sensor element and an average value of sensor signals of the two outer sensor elements is generated as a second signal curve.

29. A non-transitory medium on which is stored a computer program ascertaining a rotational speed and/or a movement variable derived from a rotational speed, including a wheel circumferential speed, using a rotational speed sensor having a plurality of sensor elements and an incremental encoder wheel, the computer program, when executed by a computer device, causing the computer device to perform the following steps:
ascertaining time intervals between temporally adjacent measurement events of the rotational speed sensor, continuously;
ascertaining at least one estimated value for at least one duty cycle of a period including at least two of the measurement events, depending on the ascertained time intervals;
correcting at least two of the time intervals depending on the estimated value; and
ascertaining the rotational speed and/or the movement variable depending on the corrected time intervals.

30. A computer device comprising:
a control device for a motor vehicle;
wherein the computer device is configured to ascertain a rotational speed and/or a movement variable derived from a rotational speed, including a wheel circumferential speed, using a rotational speed sensor having a plurality of sensor elements and an incremental encoder wheel, the computer device configured to:
ascertain time intervals between temporally adjacent measurement events of the rotational speed sensor, continuously;
ascertain at least one estimated value for at least one duty cycle of a period including at least two of the measurement events, depending on the ascertained time intervals;
correct at least two of the time intervals depending on the estimated value; and
ascertain the rotational speed and/or the movement variable depending on the corrected time intervals.
